(19) United States
(12) Patent Application Publication
(10) Pub. No.: US 2022/0069538 A1
(43) Pub. Date: Mar. 3, 2022

(54) OPTICAL FIBER DEVICES AND METHODS FOR SUPPRESSING STIMULATED RAMAN SCATTERING (SRS)

(71) Applicant: nLIGHT, Inc., Camas, WA (US)

(72) Inventors: Tyson L. Lowder, Vancouver, WA (US); Dahv A.V. Kliner, Portland, OR (US); C. Geoffrey Fanning, Portland, OR (US)

(73) Assignee: nLIGHT, Inc., Camas, WA (US)

(21) Appl. No.: 17/417,365

(22) PCT Filed: Dec. 19, 2019
(86) PCT No.: PCT/US2019/067544

§ 371 Date: Jun. 22, 2021

Related U.S. Application Data
(60) Provisional application No. 62/786,169, filed on Dec. 28, 2018.

(51) Int. Cl. H01S 3/067

(52) U.S. Cl. CPC H01S 3/06754; H01S 2301/03; H01S 3/0675

(57) ABSTRACT

Optical fiber devices, systems, and methods for separating Raman spectrum from signal spectrum Raman spectrum may be suppressed as a result of a reduction in gain and/or through dissipation while the signal spectrum may Raman Components In be propagated in one or more guided modes of a fiber system. A fiber system may Length include a propagation mode coupler to couple a first guided mode into a second guided mode with an efficiency that varies as a function of wavelength of the propagated light. Mode coupling efficiency may be higher for Raman spectrum, and lower for signal spectrum so that Raman spectrum associated with a fundamental mode is preferentially coupled into a higher-order mode. A fiber system may include a mode filter operable to discriminate between first and second guided modes. Within the filter, guiding of the first mode may be superior to that of the second mode with Raman spectrum preferentially rejected.

### CLAIM FOR PRIORITY

This application claims priority to U.S. Provisional Patent Application Ser. No. 62/786,169, filed on Dec. 28, 2018 and titled “Optical Fiber Devices and Methods for Suppressing Stimulated Raman Scattering (SRS) Light Through Guided Mode Coupling”, which is incorporated by reference in its entirety.

### BACKGROUND

The fiber laser industry continues to increase laser performance metrics, such as average power, pulse energy and peak power. Pulse energy and peak power are associated with the storage and extraction of energy in the fiber while mitigating nonlinear processes that can have adverse impacts on the temporal and spectral content of the output pulse. Stimulated Raman Scattering (SRS) light is the result of one such nonlinear process associated with quantum effects and/or vibrations of the fiber media (e.g., glass). SRS is therefore typically an undesired byproduct of fiber laser and/or fiber amplifier signal light passing through the optical fibers that make up these systems.

Generation of SRS light can reduce power in an intended signal output wavelength. SRS generation can also destabilize laser emission resulting in undesired output power fluctuations. SRS generation may also have detrimental effect on the spatial profile of laser system emission. SRS may also be re-introduced in laser and amplifier systems by reflections from objects internal to, or external to, the laser system, such as optics used to manipulate the laser or amplifier output, or the workpiece to which the laser light output is applied. Such reflections can also destabilize the laser emission. Once generated, a laser and/or amplifier of a fiber system may amplify SRS light to the point of causing catastrophic damage to components internal to the system (e.g., a fiber laser, or fiber amplifier). The SRS light may also be detrimental to components external to the fiber system because the external components may not be specified for the wavelength of the SRS light. This mismatch in wavelength between what is delivered versus what is expected can lead to undesirable performance at the workpiece or may cause an eye safety concern for the external system in which the fiber system was integrated. As such, it may be desirable to suppress SRS generation within a fiber system, remove SRS light from a fiber system, and/or otherwise mitigate one or more of the undesirable effects of SRS.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1A is a flow chart illustrating methods for selectively coupling Raman spectrum energy between guided modes of a fiber, in accordance with some embodiments;

FIG. 1B is a schematic of a device to selectively couple Raman spectrum energy between guided modes of a fiber, in accordance with some embodiments;

FIGS. 2A and 2B are longitudinal and transverse cross-sectional views of a fiber, in accordance with some embodiments;

FIG. 3 is a chart of different linearly polarized (LP) modes that Raman spectrum may be coupled between, in accordance with some embodiments;

FIG. 4A is a longitudinal cross-sectional view of a fiber length that includes a fiber Grating (FG), in accordance with some embodiments;

FIG. 4B is a transverse cross-sectional view through one portion of the FG illustrated in FIG. 4A in accordance with a symmetric FG embodiment;

FIG. 4C is a transverse cross-sectional view through one portion of the FG illustrated in FIG. 4A in accordance with an asymmetric FG embodiment;

FIG. 5A is a schematic of a device to selectively remove Raman spectrum energy from a fiber system, in accordance with some embodiments;

FIG. 5B is a schematic of a device to selectively remove Raman spectrum energy from a fiber system;

FIG. 5C is a flow chart illustrating methods of selectively removing Raman spectrum energy from a fiber system;

FIG. 6 is an isometric view of a fiber mode filter suitable for filtering higher order mode (HOM) from a system through bend losses, in accordance with some embodiments;

FIGS. 7A and 7B are cross-sectional views of fiber with the optical fiber axis in the plane of the page, in accordance with some embodiments;

FIG. 8 depicts a cross-sectional view of a differential fiber splice between a single mode fiber and a multi-mode fiber, in accordance with some embodiments;

FIG. 9 depicts a cross-sectional view of a fiber tapered to support single mode and multi-mode propagation within different fiber lengths, in accordance with some embodiments;

FIG. 10A is a schematic of a fiber system comprising an optical resonator, an optical amplifier, a Raman spectrum propagation mode coupler, and a mode filter, in accordance with some embodiments; and

FIG. 10B is a schematic of a fiber system comprising an optical resonator, an optical amplifier, a Raman spectrum propagation mode coupler, and a mode filter, in accordance with some alternative embodiments.

### DETAILED DESCRIPTION

One or more embodiments are described with reference to the enclosed figures. While specific configurations and arrangements are depicted and discussed in detail, it should be understood that this is done for illustrative purposes only. Persons skilled in the relevant art will recognize that other configurations and arrangements are possible without departing from the spirit and scope of the description. It will be apparent to those skilled in the relevant art that techniques and/or arrangements described herein may be employed in a variety of other systems and applications other than what is described in detail herein.

Reference is made in the following detailed description to the accompanying drawings, which form a part hereof and illustrate exemplary embodiments. Further, it is to be understood that other embodiments may be utilized and structural and/or logical changes may be made without departing from the scope of claimed subject matter. It should also be noted that directions and references, for example, up, down, top, bottom, and so on, may be used merely to facilitate the description of features in the drawings. Therefore, the following detailed description is not to be taken in a limiting sense and the scope of claimed subject matter is defined solely by the appended claims and their equivalents.

In the following description, numerous details are set forth. However, it will be apparent to one skilled in the art, that the present invention may be practiced without these specific details. In some instances, well-known methods and devices are shown in block diagram form, rather than in detail, to avoid obscuring the present invention. Reference throughout this specification to “an embodiment” or “one embodiment” means that a particular feature, structure, function, or characteristic described in connection with the embodiment is included in at least one embodiment of the invention. Thus, the appearances of the phrase “in an embodiment” or “in one embodiment” in various places throughout this specification are not necessarily referring to the same embodiment of the invention. Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items.

The terms “coupled” and “connected,” along with their derivatives, may be used herein to describe functional or structural relationships between components. It should be understood that these terms are not intended as synonyms for each other. Rather, in particular embodiments, “connected” may be used to indicate that two or more elements are in direct physical, optical, or electrical contact with each other. “Coupled” may be used to indicate that two or more elements are in either direct or indirect (with other intervening elements between them) physical or electrical contact with each other, and/or that the two or more elements co-operate or interact with each other (e.g., as in a cause an effect relationship).

The terms “over,” “under,” “between,” and “on” as used herein refer to a relative position of one component or material with respect to other components or materials where such physical relationships are noteworthy.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C.

The term “luminance” is a photometric measure of the luminous intensity per unit area of light travelling in a given direction. The term “numerical aperture” or “NA” of an optical system is a dimensionless number that characterizes the range of angles over which the system can accept or emit light. The term “optical intensity” is not an official (SI) unit, but is used to denote incident power per unit area on a surface or passing through a plane. The term “power density” refers to optical power per unit area, although this is also referred to as “optical intensity” and “fluence.” The term “radial beam position” refers to the position of a beam in a fiber measured with respect to the center of the fiber core in a direction perpendicular to the fiber axis. The term “radiance” is the radiation emitted per unit solid angle in a given direction by a unit area of an optical source (e.g., a laser). Radiance may be altered by changing the beam intensity distribution and/or beam divergence profile or distribution. The term “refractive-index profile” or “RIP” refers to the refractive index as a function of position along a line (1D) or in a plane (2D) perpendicular to the fiber axis. Many fibers are azimuthally symmetric, in which case the 1D RIP is identical for any azimuthal angle. The term “optical power” is energy per unit time, as is delivered by a laser beam, for example. The term “guided light” describes light confined to propagate within an optical waveguide. The term “core mode” is a guided propagation mode supported by a waveguide within one or more core of an optical fiber. The term “cladding mode” is a guided propagation mode supported by a waveguide within one or more cladding layer of an optical fiber. The term “mode coupler” is a device that couples one propagation mode of a waveguide to another propagation mode of a waveguide.

Described herein are optical fiber devices, systems, and methods suitable for one or more of suppressing SRS generation within a fiber system, removing SRS light from a fiber system, and/or otherwise mitigating one or more of the undesirable effects of SRS within a fiber system.

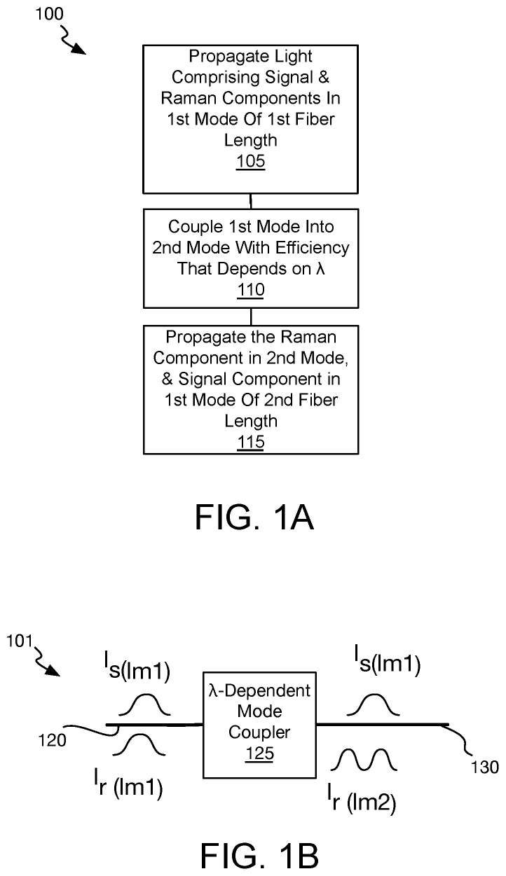

In accordance with some embodiments where light can be propagated by an optical fiber predominantly in a first mode, a Raman component Iᵣ, or a signal component Iₛ, is selectively coupled into a second propagation mode supported by the fiber. FIG. 1A illustrates methods 100 for selectively coupling Raman spectrum energy between guided modes of an optical fiber, in accordance with some embodiments. Methods 100 begin at block 105 where light is propagated over a first length of fiber predominantly in a first guided mode. The light propagated at block 105 has both a signal component Iₛ and a Raman component Iᵣ. At block 110, light is coupled into a second guided mode with a mode coupling efficiency that is a function of wavelength. For the two components Iᵣ, Iₛ, the dominant modes of propagation within a fiber are separated by a difference in the efficiency of the mode coupling between component wavelengths λᵣ, λₛ. In some exemplary embodiments, at block 110 the dominant propagation mode of the Raman component Iᵣ is coupled to another mode selectively to the signal component Iₛ. For such embodiments, methods 100 continue at block 115 where the signal component Iₛ is propagated predominantly in the first mode through a second length of fiber, while the Raman component Iᵣ is propagated through the second length of fiber predominantly in one or more modes other than the first mode. Although such embodiments are described in further detail herein, it is noted techniques and/or devices similar to those provided may be employed to instead selectively couple the signal component Iₛ from a first mode into a second mode. In either implementation, with the Raman component propagating in a different mode than the signal component the Raman component may experience lower gain from the signal component as a result of relatively lower overlap between their modes. Mode-based filtering may also then be utilized, for example to increase propagation losses for the Raman component.

FIG. 1B is a schematic of a device 101 to selectively couple Raman spectrum energy between guided modes of a fiber, in accordance with some embodiments. Device 101 may be operable to perform methods 100, for example. As shown, device 101 includes a propagation mode coupler 125 coupled to receive light propagating in a first fiber length 120, and coupled to pass light propagating in a second fiber length 130. Light propagated within both fiber lengths 120 and 130 may comprise a signal component Iₛ and a Raman component Iᵣ. The signal component Iₛ has some range of intensities over a predetermined signal spectrum comprising one or more signal wavelengths (e.g., with a micrometer center wavelength, such as 1050 nm, etc.). Similarly, the Raman component Iᵣ has some range of some intensity over a Raman spectrum. In general, the Raman component Iᵣ can be expected to span wavelengths longer than those of the signal component Iₛ (e.g., a Raman-shifted center wavelength, such as 1100 nm, etc.). The Raman component Iᵣ may also have a wider band than the signal component Iₛ.

As shown, both the signal component Iₛ and the Raman component Iᵣ propagates in a first guided mode lm₁ of fiber length 120. In some examples, the first guided mode is a linear polarized mode LPₗₘ, with one embodiment being the linearly polarized fundamental transverse mode of the optical fiber, LP₀₁. LP₀₁, which has desirable characteristics in terms of beam shape, minimal beam expansion during propagation through free space (often referred to as “diffraction limited”), and optimum focus-ability. Hence, fundamental mode LP₀₁ propagation is often advantageous in the fiber laser industry.

A wavelength sensitive propagation mode coupler 125 is to couple at least some of the light in the first (core) guided mode into a second (core) guided mode supported by fiber length 130. Propagation mode coupler 125 is wavelength sensitive and therefore has a mode coupling efficiency over the Raman spectrum that is different from that over the signal spectrum. In exemplary embodiments, propagation mode coupler 125 has higher mode coupling efficiency within the Raman spectrum than within the signal spectrum, and therefore may be considered “Raman-selective,” or a “Raman” propagation mode coupler. Although, propagation mode coupler 125 may employ free-space optics, in some exemplary embodiments propagation mode coupler 125 is a fiber mode coupler comprising a length of fiber. In some embodiments, propagation mode coupler 125 is embedded within a length of fiber substantially the same as fiber length 130, as described in greater detail elsewhere herein.

Fiber length 130 is suitable for supporting at least two guided modes (i.e., fiber length 130 comprises multi-mode, or MM fiber). Signal component Iₛ is to propagate in the first guided mode lm₁ (e.g., LP₀₁) of fiber length 130, while the Raman component Iᵣ is to propagate in the second guided mode 1m₂. In some embodiments, the second guided mode 1m₂ is a higher order mode than the first mode lm₁. For example, where the first guided mode is the fundamental transverse mode, the second guided mode lm₂ may be any higher-order mode (HOM). Raman spectrum propagation mode coupler 125 may couple between the first propagation mode and one or more second propagation modes (e.g., any number of HOM). In some exemplary embodiments, fiber length 120 comprises single-mode (SM) fiber. However, fiber length 120 may also support multiple guided modes (MM fiber), in which case light may also be propagated in more than one first mode (e.g., lmᵢ) within fiber 120. For such embodiments light is then to be propagated in at least one additional mode (e.g., lmᵢ₊₁) with fiber length 130.

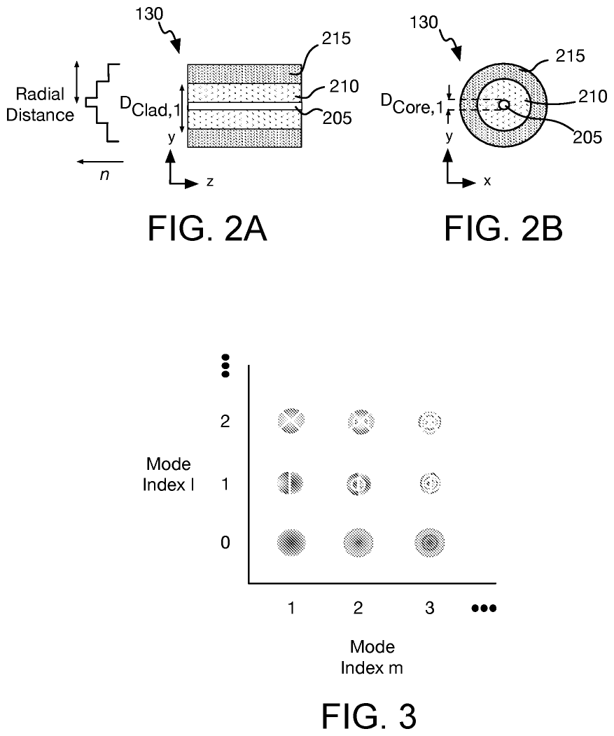

FIGS. 2A and 2B are longitudinal and transverse cross-sectional views of fiber length 130, respectively, in accordance with some multi-clad fiber embodiments. Although a double clad fiber embodiment is illustrated, fiber length 130 may have any number of cladding layers (e.g., single, triple, etc.) known to be suitable for optical fiber. In the example illustrated in FIG. 2A and 2B, fiber length 130 has a central core 205, and an inner cladding 210, which is annular and encompasses central core 205. An annular outer cladding 215 surrounds inner cladding 210. Core 205 and inner cladding 210 may have any suitable composition (e.g., glass). Outer cladding 215 may be a polymer or also glass, for example. Although not depicted, one or more protective (non-optical) coatings may further surround outer cladding 215.

Fiber length 130 may have any suitable refractive index profile (RIP). As used herein, the “refractive-index profile” or “RIP” refers to the refractive index as a function of position along a line (e.g., x or y axis in FIG. 2B) or in a plane (e.g. x-y plane in FIG. 2B) perpendicular to the fiber axis (e.g., z-axis in FIG. 2A). In the example shown in FIG. 2B, the RIP is radially, or rotationally, symmetric, in which case the RIP is identical at any azimuthal angle. Alternatively, for example as for birefringent fiber architectures, RIP may vary as a function of azimuthal angle. Core 205, inner cladding 210, and outer cladding 215 can each have any RIP, including, but not limited to, a step-index and graded-index. A “step-index fiber” has a RIP that is substantially flat (refractive index independent of position) within fiber core 205. Inner cladding 210 may also have a substantially flat RI over D_{Clad,1}, with a RIP of fiber length 130 stepped at the interface between core 205 and inner cladding 210. An example of one illustrative stepped RIP suitable for a fiber laser is shown in FIG. 2A. Alternatively, one or more of core 205 and inner cladding 210 may have a “graded-index” in which the RI varies (e.g., decreases) with increasing radial position (i.e., with increasing distance from the core and/or cladding axis).

In accordance with some embodiments, core 205 is operable for multi-mode propagation of light. With sufficient core diameter D_{core,1}, and/or NA contrast, fiber length 130 supports the propagation of more than one transverse optical mode. Fiber length 130 may comprise large mode area (LMA) fiber that is operable in an LMA regime, or fiber length 130 may comprise strongly multi-mode fiber that supports hundreds of modes within core 205. For LMA fiber, the number of modes supported in a fiber generally scales with V-number. The V-number is proportional to core diameter D_{core,1} and the core numerical aperture (NA), and is inversely proportional to the wavelength(s) of the light propagating in the fiber (e.g., λₛ−λ_{R}). In some LMA embodiments, the number of modes supported by core 205 is given by roughly one half the square of the V-number. It can be shown that a fiber with a V-number less than about 2.4 supports the propagation of only the fundamental mode while optical fibers having a V-number over 2.4, can support several optical modes.

Referring still to FIGS. 2A and 2B, inner cladding 210 may have an area larger than that of the core 205, and may also have a higher NA. Cladding 210 may also support a large number of propagation modes. Nevertheless, in accordance with some advantageous embodiments, mode coupler 125 is to couple the Raman component Iᵣ into a core mode (i.e., a guided mode). Although core 205 and inner cladding 210 is illustrated as being concentric (i.e., a centered core), they need not be. One or more of core 205 and inner cladding 210 may also be a variety of shapes other than circular, such as, but not limited to annular, polygonal, arcuate, elliptical, or irregular. Core 205 and inner cladding 210 in the illustrated embodiments are co-axial, but may alternatively have axes offset with respect to one another. Although D_{Clad,1} and D_{Core,1} are illustrated to be constants about a central fiber axis in the longitudinal direction (z-axis in FIG. 2A). The diameters D_{clad,1} and D_{Core,1} may instead vary over a longitudinal fiber length 130. In some exemplary embodiments, the core diameter D_{Core,1} is in the range of 10-100 micron (μm) and the inner cladding diameter D_{Clad,1} is in the range of 200-1000 μm, although other values for each are possible.

In further reference to device 101 (FIG. 1B), fiber length 120 may have any of the properties described above for fiber length 130. In some embodiments, fiber length 120 has substantially the same core and cladding architecture as fiber length 130. For example, fiber length 120 may also comprise double-clad fiber. Fiber length 120 may be substantially identical to fiber length 130, for example having the same core and cladding architecture, compositions, and dimensions (e.g., diameters). For such embodiments, fiber length 120 also supports multiple guided modes. In alternative embodiments where fiber length 120 comprises single mode fiber (e.g., V-number <2.4), one or more property of the core (e.g., NA or diameter) within fiber length 120 differs from (e.g., is smaller than) that of fiber length 130.

FIG. 3 is a chart depicting a subset of linearly polarized (LP) modes between which a mode coupler may propagate Raman spectrum. For embodiments where a Raman component Iᵣ is propagated in fundamental mode (e.g., LP₀₁), the Raman component Iᵣ may be coupled into any of the higher 0^{th} order modes (e.g., LP₀₂, LP₀₃), any of the 1^{st} order modes (e.g., LP₁₁), or any even higher order modes (HOM) (e.g., LP₂₁). In some embodiments, mode coupler 125 is to preferentially couple a Raman component Iᵣ propagating in the fundamental mode (e.g., LP₀₁) into an odd-ordered mode (e.g., LP₁₁). A given HOM may have more or less spatial overlap with the LP₀₁ mode. Generally, an odd-ordered HOM (e.g., LP₁₁) will have less spatial overlap with the LP₀₁ mode than does an even-ordered HOM. Although Raman component Iᵣ may be coupled from the fundamental mode into more than one HOM, when a fiber system further includes a propagation mode filter, the dominant mode to which the Raman component Iᵣ is coupled is advantageously an odd-ordered mode.

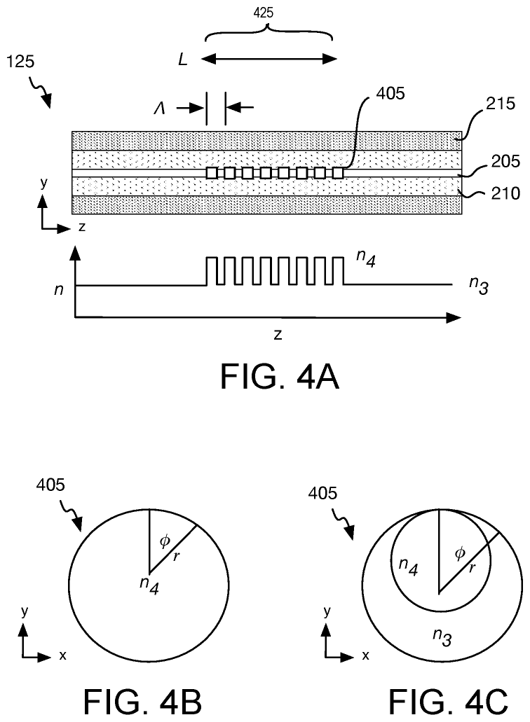

Raman propagation mode coupler 125 may take a variety of forms. Some exemplary fiber mode couplers comprise a length of multi-mode fiber that further includes a fiber grating (FG). In contrast to a bend, a FG may induce mode coupling (e.g. from the fundamental mode to HOM) that is sufficiently wavelength selective to distinguish between Raman spectrum and signal spectrum. The FG may have a variety of architectures, including, but not limited to a fiber Bragg grating (FBG), and a long-period fiber grating (LPFG). FG embodiments may be designed with a variety of architectures that are operable to couple a given spectral bandwidth (e.g., Raman component Iᵣ) from a first guided mode (e.g., LP₀₁) to a second, counter-propagating reflected mode (e.g., LP₁₁). FIG. 4A is a longitudinal cross-sectional view of a length of fiber that includes an exemplary mode coupler 125 that further comprises a fiber grating 425, in accordance with some embodiments. Fiber grating 425 is to interact with the core modes electric field. This can be direct interaction or more evanescently. Fiber grating 425 can therefore be in the cladding or even comprise external surface perturbations. In the example shown, fiber grating 425 comprises refractive index (RI) perturbations 405 within at least fiber core 205 over a grating length L. In the example, RI perturbations 405 have a refractive index (n₄) that is higher than a nominal core RI (n₃). For embodiments where outer cladding 215 has an RI of n₁, and inner cladding 210 has an RI of n₂, RI within propagation mode coupler 125 may vary as n₁<n₂<n₃<n₄. For FBG embodiments, RI perturbations 405 may impact light guided within core 205 over only a narrow range of wavelengths that satisfy a Bragg condition. Light at other wavelength where a Bragg condition is not satisfied may be substantially unaffected by RI perturbations 405. Bandwidth for a FBG may be only 1-5 nm, for example, which may be tuned to target a center wavelength of a Raman component Iᵣ, and reflect at least a portion of Raman spectrum into a higher-order counter propagating mode.

RI perturbations 405 are illustrated to have a period of Λ. Grating period Λ may vary according to implementation. For FBG embodiments operable to reflect the Raman component Iᵣ into high-order counter propagating mode(s), grating period Λ may be short, for example no more than half of a center Raman wavelength (e.g., 200-400 nm). For LPFG embodiments that are to couple light into co-propagating HOM modes that are also supported by central core 205, grating period Λ may be greater than half of the center Raman wavelength. In some of these embodiments, grating period Λ is two or more times half the center Raman wavelength, for example ranging from 100-1000 μm. Although a fixed period fiber grating is illustrated in FIG. 4A, aperiodic (i.e., chirped), apodized, or superstructure grating embodiments may also be suitable implementations of a fiber mode coupler. For example, chirped embodiments of either Bragg or long-period grating architectures may offer a wider spectral response (e.g., >5 nm) than their periodic counterparts. Apodized embodiments of either Bragg or long-period grating architectures may, for example, improve mode separation of the Raman spectrum from signal spectrum. Superstructure embodiments may include a variety of grating structures (e.g., including both chirp and apodization structures).

A mode coupling efficiency associated Raman mode coupler 125 may depend not only on the amplitude of RI modulation and the grating length L, but also on a three-dimensional shape of the grating. In some embodiments, a mode coupler comprises a cylindrically, or rotationally, symmetric grating with RI perturbations being independent of azimuthal angle (e.g., substantially orthogonal to the fiber axis) and/or core radius. FIG. 4B is a transverse cross-sectional view through one portion of fiber grating 425 in accordance with a rotationally symmetric grating embodiment. As shown, within an x-y plane of an RI perturbation 405 the index is independent of azimuthal angle φ and core radius r (e.g., RI being n₄ everywhere within the x-y plane). In some alternative embodiments, a Raman propagation mode coupler comprises a cylindrically asymmetric grating with RI perturbations that are dependent on azimuthal angle (e.g., slanted from orthogonal to the fiber axis) and/or core radius. FIG. 4C is a transverse cross-sectional view through one portion of fiber grating 425, in accordance with cylindrically (rotationally) asymmetric, or slanted, FG embodiments. As shown, the index may be dependent on azimuthal angle φ (e.g., varying from n₃ to n₄) and/or core radius r within an x-y plane of RI perturbation 405.

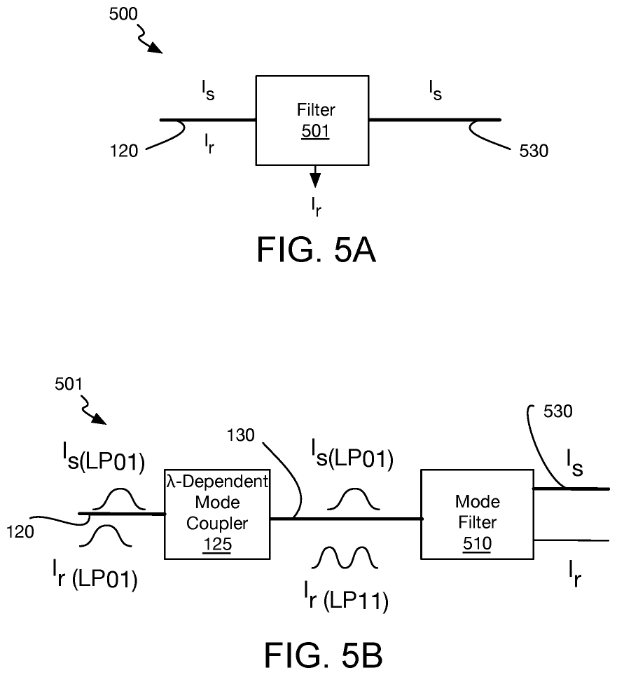

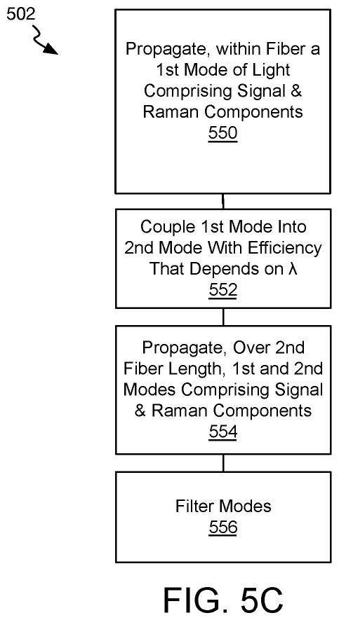

FIG. 5A is a schematic of a fiber device 500 to selectively remove Raman spectrum energy from a fiber system, in accordance with some embodiments. Fiber device 500 includes a Raman filter 501 coupled to receive light propagated in fiber length 120 that again includes both signal and Raman components Iₛ, Iᵣ. Raman filter 501 is operative to discriminate the Raman component Iᵣ from the signal component Iₛ, upon which the Raman component Iᵣ may be selectively routed to a destination different than that of the signal component Iₛ, which is to propagate in fiber length 530. As a result of filtering, light propagated within fiber length 530 has a reduced Raman component Iᵣ. Once filtered, Raman component Iᵣ may be selectively dissipated and/or suppressed.

In some embodiments, Raman filter 501 includes a Raman wavelength sensitive propagation mode coupler operable to selectively couple Raman spectrum energy into one or more guided modes that are other than the dominant mode of the signal spectrum energy. Raman filter 501 further includes a propagation mode filter, distinct from the Raman propagation mode coupler, which is further operable to discriminate between at least one guided mode propagating the Raman spectrum, and at least one guided mode propagating the signal spectrum. The architecture of Raman filter 501 is in contrast to a filter that employs a device that is to unguide some spectrum from the core, for example into a guided cladding mode, or completely out of the fiber.

FIG. 5B is a schematic of some exemplary embodiments of Raman filter 501 operable to remove Raman spectrum energy from a fiber system. As shown, Raman filter 501 includes propagation mode coupler 125 and a propagation mode filter 510. Propagation mode coupler 125 may have any of the attributes described above, and in this example is operable to couple the Raman component Iᵣ, propagated in the fundamental mode (e.g., LP₀₁) of fiber length 120, into one or more co-propagating, or counter-propagating, guided HOMs (e.g., LP₁₁) of fiber length 130. Being wavelength sensitive, propagation mode coupler 125 is to pass the signal component Iₛ, which is further propagated in the fundamental mode (e.g., LP₀₁) of fiber lengths 120 and 130. Propagation mode filter 510 is to guide the fundamental mode (e.g., LP₀₁) more efficiently than one or more co-propagating or counter-propagating higher-order modes (e.g., LP₁₁). For example, propagation mode filter 510 may be configured to strip from the fiber one or more HOMs in favor of fundamental mode propagation. For embodiments where propagation mode coupler 125 renders one of those HOMs the dominant mode of the Raman component Iᵣ, propagation mode filter 510 may strip, attenuate, or suppress the Raman component Iᵣ.

FIG. 5C is a flow chart illustrating methods 502 of selectively removing Raman spectrum energy from a fiber system. Methods 502 may be practiced by Raman filter 501, for example. At block 550, light comprising both signal and Raman components Iᵣ, Iₛ is guided in a first propagation mode of a fiber core. At block 552, the first propagation mode is coupled into one or more second propagation modes of the fiber core with a coupling efficiency that has a sufficient dependency upon wavelength to discriminate between the spectrums of the signal and Raman components Iᵣ, Iₛ. For example, coupling efficiency may peak near a center wavelength of the Raman spectrum and decline by half, or more, within l0nm of the center wavelength of the Raman spectrum). At block 554, light comprising both signal and Raman components Iᵣ, Iₛ is guided in multiple propagation modes of a fiber. At block 556, light is filtered in a manner that suppresses at least a dominant propagation mode of the Raman component Iᵣ and/or more efficiently guides a dominant propagation mode of the signal component Iₛ. Propagation mode filtering at block 556 may be according to any technique. Because of the wavelength dependence of the mode coupling at block 554, mode filtering at block 556 may be implemented with wavelength insensitive devices and/or techniques. Mode filtering may be achieved, for example with a fiber-based technique such as, but not limited to, fiber bends, fiber architecture transitions (e.g., SM-MM-SM transitions), fiber temperature modulation, and/or fiber strain (e.g., fiber stretching).

In some embodiments, mode filter 510 is a fiber mode filter comprising one or more lengths of fiber that selectively leak or lose higher-order modes. For some such embodiments, a propagation mode filter comprises fiber that has a sufficiently small bend radius over a sufficient bend length to lose significant energy from of a higher-order propagation mode conveying primarily Raman spectrum. Such bend losses may be a result of coupling a guided HOM to a non-guided (and thus lossy) mode of the fiber. For example, mode filter 510 may couple a guided HOM into a cladding mode or dissipation mode while the signal spectrum energy remains in the dominant lower-order propagation mode of the fiber core.

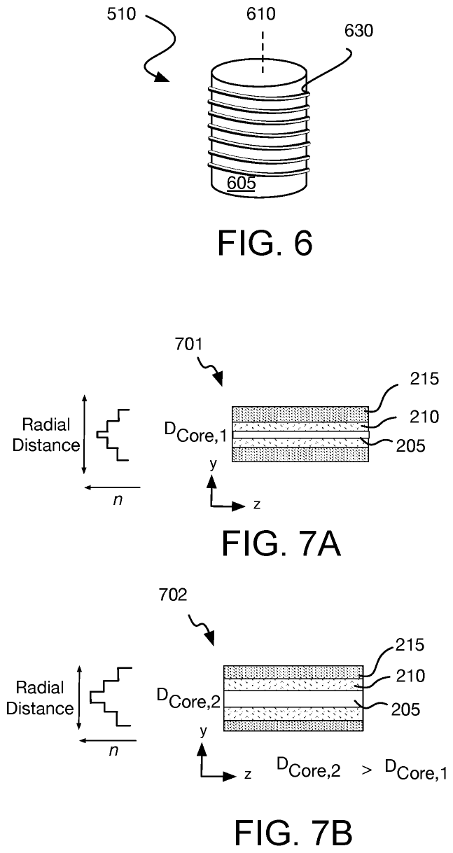

FIG. 6 illustrates an isometric view of a fiber mode filter 510 suitable for filtering HOM from a fundamental mode through bend losses, in accordance with some embodiments. Mode filter 510 includes a length of fiber 630 coiled about a mandrel 605 in either a two-dimensional (2D) form with bending occurring only about one axis of curvature, or a 3D form with bending in two orthogonal axes of curvature (not illustrated). Generally, bending losses are greater for modes orthogonal to the axis of curvature than for modes parallel to the axis of curvature. Mandrel 605 has a longitudinal axis 610 parallel to the axis of curvature and defines a fixed radius of curvature over the bend length. Fiber length 630 may be substantially as described above for fiber length 130 (e.g., a double clad, cylindrically symmetric RIP, etc.). Alternatively, fiber length 630 may comprise fiber having properties particularly conducive to controlling HOM losses, such as but not limited to a polarization-maintaining (PM) core shape and/or cladding configuration. For example, fiber length 630 may have a rotationally asymmetric core, which is angularly rotated over fiber length 630, for example to ensure bending losses are experienced in orthogonally oriented higher-order modes. In a radially asymmetric fiber, the transverse refractive index depends not only on the radius r, but also on the azimuthal coordinate co. In other words, the mode filter fiber may have an azimuthally asymmetric refractive-index profile. With polarization-maintenance, higher-order modes remain oriented relative to a reference core axis (e.g., major axis fiber 630) over the bend length. Angular rotation about the fiber axis (i.e., axial rotation) over the bend length would therefore rotate the mode density distribution in sync with the core orientation. In some embodiments, within mode filter 510 angular rotation of a PM fiber about the fiber axis is at least 90° over a bend length that attenuates all higher-order modes by some threshold (e.g., 3 dB, 10 dB, etc.). For further discussion of propagation mode filter design, the interested reader is referred to U.S. Pat. No. 8,711,471 and U.S. Pat. No. 9,917,410, for example.

Mode filter 510 may have any bend length required to attenuate higher-order modes conveying the Raman spectrum by some predetermined threshold (e.g., 3 dB high-order modal suppression, 10 dB, etc.). Depending on the coiling path, the bend length need not be continuous and may instead be accumulated by incremental bends separated by straight runs (e.g., as for a racetrack coiling path). To advantageously minimize bending loss incurred by the fundamental mode conveying the signal spectrum, the bend length may be minimized to achieve a minimum threshold of higher-order modal attenuation. Although fiber length 630 is multi-mode fiber capable of supporting multiple propagation modes, it can be rendered single mode through bend losses. Hence, even where fiber length 630 has the same properties as fiber length 130 described above, within mode filter 510 a single mode (e.g., LP₀₁, or any other dominant propagation mode of the signal component Iₛ) may be enforced over the bend length. Notably, Raman spectral energy may be removed over the entire bend length associated with mode filter 510. Mandrel 605 may further serve as a good heat sink, efficiently dissipating Raman spectral energy.

In some other embodiments, mode filter 510 is a fiber mode filter comprising one or fiber transitions such as, but not limited to a splice between two distinct fibers, or a more gradual transition of the type that may be implemented during a fiber draw or through some other post draw processing method (e.g., flame splicer, etc.). For such embodiments, the transition is to selectively block, leak, or otherwise lose, at least the higher-order propagation mode of the Raman component Iᵣ. For some embodiments, a propagation mode filter comprises transition between a first length of fiber and a second length of fiber. The first length of fiber is to support multiple propagation modes that include both the dominant mode of a Raman component Iᵣ, and the dominant mode of the signal component Iₛ. However, the second length of fiber is to be unable to support the dominant mode of the Raman component Iᵣ, and may, for example, support only the dominant mode conveying the signal component Iₛ.

FIGS. 7A and 7B are cross-sectional views of two fiber lengths 701 and 702, respectively, each with the optical fiber axis in the plane of the page, in accordance with some embodiments. As shown, fiber length 701 comprises a double-clad fiber having core 205, inner cladding 210 and outer cladding 215. For such double-clad fiber embodiments, fiber length 701 may have any of the attributes described above for fiber length 130, for example. Single clad fiber embodiments are also possible, as are triple-clad or any other multi-clad fiber design. In the example shown in FIG. 7A, fiber length 701 has a RIP that is cylindrically symmetric about the fiber axis with RI value n being highest within core 205, and stepped down to lower values in inner cladding 210 and outer cladding 215. As further shown in FIG. 7B, fiber length 702 also comprises a double-clad fiber having core 205, inner cladding 210 and outer cladding 215. For such double-clad fiber embodiments, fiber length 702 may also have any of the attributes described above for fiber length 130. Single clad, triple-clad or any other multi-clad fiber designs are therefore also suitable for fiber length 702. In the example shown in FIG. 7B, fiber length 702 has a RIP that is cylindrically symmetric about the fiber axis with RI value n being highest within core 205, and stepped down to lower values in inner cladding 210 and outer cladding 215.

In accordance with some embodiments, fiber length 702 has a fiber architecture suitable for supporting multiple propagation modes within core 205, while fiber length 701 has a fiber architecture that is unable to support more than one propagation mode within core 205. In some such embodiments, within fiber length 702 core 205 has a dimension D_{core,2} that is larger than core dimension D_{core,1} of fiber length 701. A propagation mode filter may include both fiber lengths 701 and 702 with a transition between the two fiber lengths then operative as a filter of a higher-order mode that is the dominant propagation mode of the Raman component Iₛ propagated within a fiber system.

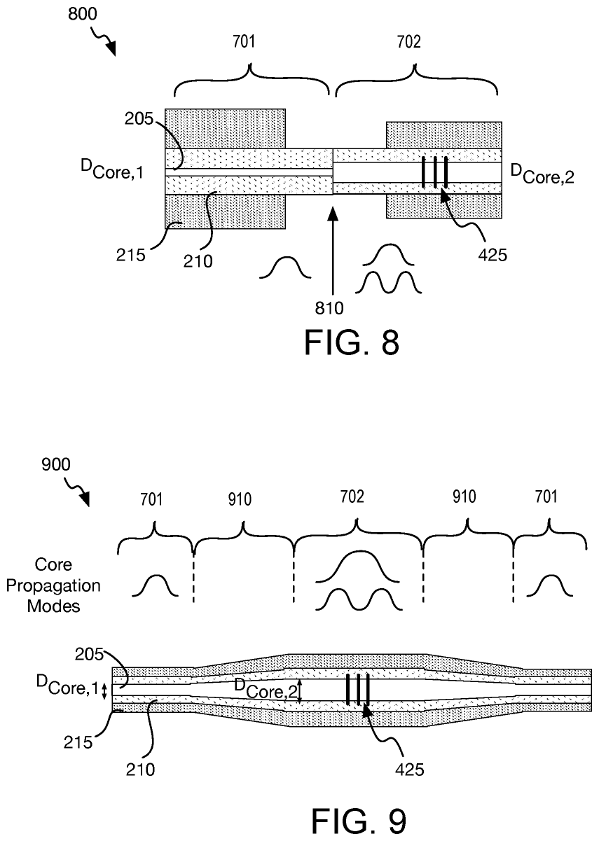

FIG. 8 depicts a cross-sectional view of a fiber device 800 that includes a differential fiber splice 810 between a single mode fiber length 701, and a multi-mode fiber length 702. Differential fiber splice 810 may be operable as mode filter 510 (FIG. 5B) where differences in the core (e.g., diameter and/or NA) force higher-order mode propagating within fiber length 702 to become lossy at the transition to fiber length 701. More specifically, fiber splice 810 is a differential core splice where some core light propagating as a higher-order core mode (e.g., LP₁₁) within fiber length 702 will couple into cladding modes and/or dissipation modes that enter inner cladding 210 within fiber length 701. Such cladding modes may propagate within inner cladding 210, and/or pass through inner cladding 210, and into (or through) outer cladding 215. Core light propagating as a fundamental core mode (e.g., LP₀₁) within fiber length 702 will however more efficiently couple into a fundamental core mode within fiber length 701 where it may continue to propagate as a guided mode.

In some further embodiments, multi-mode fiber length 702 may further comprise a fiber propagation mode coupler, for example substantially as described elsewhere herein. Fiber device 800 may therefore be one implementation of fiber device 501, introduced above (FIG. 5B). In the example illustrated in FIG. 8, fiber length 702 further comprises fiber grating 425. In the context of fiber device 800, fiber grating 425 may have any of the attributes described elsewhere herein. For example, in the context of fiber device 800, fiber grating 425 may again be a short-period FBG, a LPFG, have a chirped and/or apodized architecture, and/or comprise a superstructure, etc. When fiber device 800 is inserted within a fiber system that otherwise comprises single-mode fiber, the resulting system may further comprise a second fiber transition that joins fiber length 702 within another length of single mode fiber. With proper launch into the MM fiber, signal spectrum propagated in the SM fibers can be maintained by the MM fiber so that one or more of the SM-MM-SM fiber transitions may combine with a mode coupler within the MM fiber to suppress higher-order Raman modes.

FIG. 9 depicts a cross-sectional view of a fiber device 900 comprising a tapered fiber length 910 that transitions between fiber length 701 that supports single mode propagation, and fiber length 702 that supports multi-mode propagation, in accordance with some embodiments. Fiber lengths 701 and 702 may each be substantially as described above in the context of FIGS. 7A, 7B, and 8. As illustrated in FIG. 9, fiber length 702 supports at least a fundamental core propagation mode (e.g., LP₀₁) as well as one or more HOMs (e.g., LP₁₁), while fiber length 701 supports only the fundamental core propagation mode. Tapered fiber length 910 has a core property (e.g., diameter and/or NA) that gradually (e.g., linearly) transitions between the core properties of fiber lengths 701 and 702. For the illustrated example, where the core diameter within tapered fiber length 910 linearly varies as a function of longitudinal position, a higher-order mode propagating within fiber length 702 may be expected to expand/contract within fiber length 910 where it eventually couples strongly into cladding modes of fiber length 701. For the embodiments illustrated in FIG. 9, fiber length 701 is between two fiber lengths 702 with a tapered fiber length 910 surrounding fiber length 701. Such an architecture may allow for expansion and contraction of the fundamental mode. Other embodiments with only one tapered fiber length 910 are also possible.

In the illustrated embodiments of fiber device 900, multi-mode fiber length 702 further comprises a propagation mode coupler, which may have any of the attributes described above. Fiber device 900 may therefore be another implementation of fiber device 501 (FIG. 5B). In the example illustrated in FIG. 9, fiber length 702 further comprises fiber grating 425. In the context of fiber device 900, fiber grating 425 may have any of the attributes described elsewhere herein. For example, fiber grating 425 may again be a short-period FBG, a LPFG, have a chirped and/or apodized architecture, and/or comprise a superstructure, etc. When fiber device 900 is inserted within a fiber system that otherwise comprises single-mode fiber, that system may further comprise a second fiber transition that joins fiber length 702 within another length of single mode fiber. With proper launch into the MM fiber, signal spectrum propagated in the SM fibers can be maintained by the MM fiber so that one or more of the SM-MM-SM fiber transitions may combine with a mode coupler within the MM fiber to suppress higher-order Raman modes.

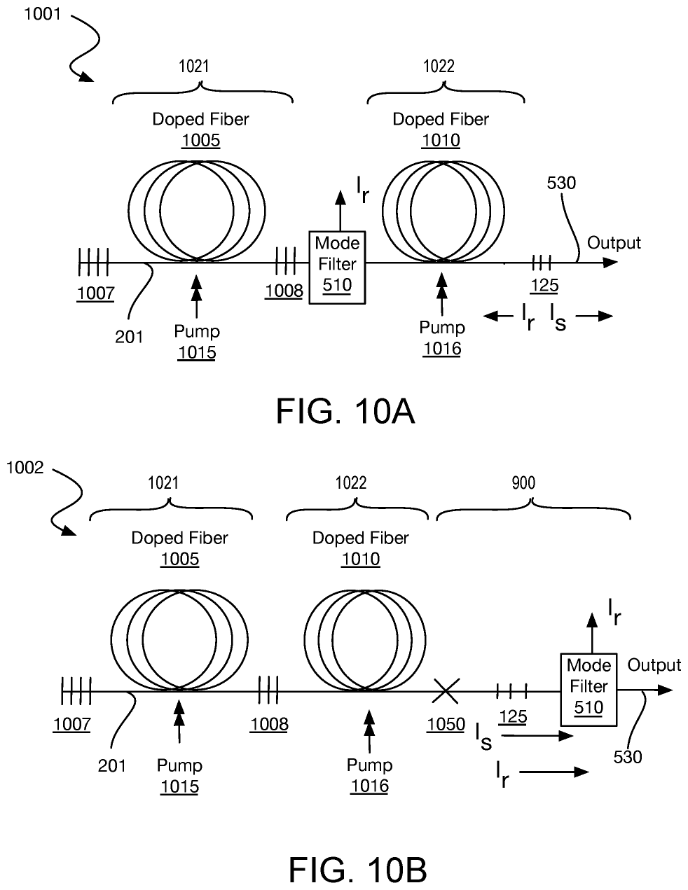

One or more of the fiber devices described above may be incorporated into a larger fiber system, for example one that includes a fiber resonator or cavity, and/or includes a fiber amplifier. FIG. 10A, for example, is a schematic of a fiber laser system 1001 that comprises both an optical resonator 1021, and an optical amplifier 1022. System 1001 further includes a Raman spectrum propagation mode coupler 125 suitable for selectively coupling Raman spectrum between propagation modes. Notably, in the presence of mode coupler 125, Raman spectrum in higher-order modes of laser system 1001 can be expected to have lower gain by the signal spectrum due to lower mode overlap. As such, mode coupler 125 may be employed with or without the further integration of propagation mode filter 510, which is suitable for selectively filtering those modes conveying Raman spectrum, in accordance with some further embodiments.

Fiber resonator 1021 is to generate an optical beam by exciting a signal spectrum of light. Resonator 1021 is defined by a strong fiber grating 1007 and a fiber-to-fiber coupler (FFC) 1008 with a doped fiber length 1005 therebetween. Doped fiber length 1005 may comprise a variety of materials, such as, SiO₂, SiO₂ doped with GeO₂, germanosilicate, phosphorus pentoxide, phosphosilicate, Al₂O₃, aluminosilicate, or the like, or any combinations thereof. In some embodiments, the dopants comprise rare-earth ions such as Er³⁺ (erbium), Yb³⁺ (ytterbium), Nd³⁺ (neodymium), Tm³⁺ (thulium), Ho³⁺ (holmium), or the like, or any combination thereof. Doped fiber length 1005 may comprise a multi-clad fiber, for example substantially as described above for fiber length 130. Doped fiber length 1005 may alternatively comprise a single-clad fiber, or any other fiber architecture known to be suitable for a fiber laser. Fiber resonator 1021 is optically coupled to a pump light source 1015, which may be a solid state diode laser, or lamp, for example. Pump light source 1015 may be coupled into a cladding layer of doped fiber 1005 in either a co-propagating or counter-propagating manner. In some embodiments, doped fiber length 1005 comprises multi-mode fiber supporting multiple propagation modes within a fiber core (e.g., substantially as described above for fiber 130). However, in some alternative embodiments doped fiber length 1005 comprises a single-mode fiber capable of supporting only one guided propagation mode within the fiber core.

Fiber amplifier 1022 is to intensify at least the signal spectrum excited by resonator 1021. Fiber amplifier 1022 is optically coupled to a pump light source 1016, which may also be a solid state diode laser, or lamp, for example. Fiber amplifier 1022 includes a doped fiber length 1010, which may have any of the properties described above for doped fiber length 1005. For example, in some embodiments, doped fiber length 1010 comprises rare-earth ions such as Er³⁺ (erbium), Yb³⁺ (ytterbium), Nd³⁺ (neodymium), Tm³⁺ (thulium), Ho³⁺ (holmium), or the like, or any combination thereof. Doped fiber length 1010 may comprise a multi-clad fiber, for example substantially as described above for fiber length 130. In some embodiments, doped fiber length 1010 comprises a multi-mode fiber supporting multiple propagation modes within a fiber core (e.g., substantially as described above for fiber 130). In some advantageous embodiments where doped fiber length 1005 comprises single-mode fiber operable to support only one guided propagation mode within the fiber core, and doped fiber length 1010 comprises a multi-mode fiber supporting multiple propagation modes within the fiber core, mode filter 510 may be implemented by a differential splice between doped fiber lengths 1005 and 1010, for example substantially as described for fiber device 800 (FIG. 8A-8B). Hence, fiber device 800 may be integrated directly into fiber system 1001 with the differential splice between a single-mode resonator 1021 and multi-mode amplifier 1022 functional as a mode filter suitable for filtering and/or suppressing Raman spectral energy. Alternatively, mode filter 510 may be implemented with tapered fiber transition, for example substantially as described for fiber device 900 (FIG. 9).

In some fiber systems including both a propagation mode coupler and a propagation mode filter, at least one of the mode coupler and mode filter is positioned between a resonator and an amplifier. In the example illustrated by FIG. 10A, mode filter 510 is positioned between resonator 1021 and amplifier 1022, while mode coupler 125 is within a length of multi-mode fiber on the amplifier side of mode filter 510. Such architecture is well-suited to a doped fiber length 1010 that comprises multi-mode fiber, as mode coupler 125 may then be fabricated directly within a portion of the multi-mode fiber (or a low-loss splice may join doped fiber length 1010 to another length of multi-mode fiber comprising mode coupler 125). When in the position illustrated in FIG. 10A, mode coupler 125 may advantageously be a short-period (Bragg) fiber grating such that Raman component Iᵣ may be reflected to counter propagate toward mode filter 510 while signal spectrum Iₛ may propagate within fiber length 530 toward an output of fiber system 1001 (e.g., a delivery fiber and/or process head, etc.).

FIG. 10B is a schematic of a fiber system 1002 comprising optical resonator 1021, optical amplifier 1022, Raman spectrum propagation mode coupler 125, and mode filter 510, in accordance with some alternative embodiments. Each component of fiber system 1002 may have any of the properties and/or attributes described elsewhere herein. As shown, fiber system 1002 has an architecture similar to that of fiber system 1001 with the exception that mode coupler 125 is separated from optical resonator 1021 by amplifier 1022. In this specific example, mode coupler 125 is between optical resonator 1021 and mode filter 510. Alternatively, mode filter 510 may be between optical amplifier 1021 and mode coupler 125. For the configuration illustrated, it may be advantageous for mode coupler 125 to be a LPFG, with Raman component Iᵣ then to be co-propagated with signal spectrum Iₛ to mode filter 510 where it is removed at least in part from system 1002. Signal spectrum Iₛ is to propagate within fiber length 530 toward an output of fiber system 1002 (e.g., a delivery fiber and/or process head, etc.). The configuration of system 1002 is well-suited, for example, to a fiber system in which resonator 1021 and amplifier 1022 are both single mode fiber devices (i.e., fibers 1005 and 1010 have single-mode architecture). Mode coupler 125 may then be fabricated within a portion of MM fiber that is joined to fiber length 1010, for example at a splice 1050. For the illustrated embodiments, splice 1050 joins fiber length 1010 to fiber device 900, which implements mode coupler 125 and mode filter 510, for example substantially as described in the context of FIG. 9.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure. It will be recognized that the invention is not limited to the embodiments so described, but can be practiced with modification and alteration without departing from the scope of the appended claims. The above embodiments may include the undertaking of only a subset of such features, undertaking a different order of such features, undertaking a different combination of such features, and/or undertaking additional features than those features explicitly listed. The scope of the invention should therefore be determined with reference to the appended claims, along with the full scope of equivalents to which such claims are entitled.

1. A fiber optic device, comprising:
a first length of optical fiber comprising a core and one or more cladding layers, wherein the first length of fiber supports at least a first guided mode for light comprising both signal spectrum and Raman spectrum;
a second length of optical fiber comprising a core and one or more cladding layers, wherein the second length of optical fiber supports multiple guided modes; and
a propagation mode coupler between the first and second lengths of fiber, the propagation mode coupler to couple at least some of the light propagated in the first guided mode into a second guided mode with a mode coupling efficiency over the Raman spectrum that differs from that over the signal spectrum.

2. The fiber optic device of claim 1, further comprising a propagation mode filter coupled to receive the light from the first or second lengths of fiber, and to discriminate between the first and second guided modes.

3. The fiber optic device of claim 1, wherein:
the second guided mode is of a higher-order than the first guided mode;
the Raman spectrum comprises one or more first wavelengths that are longer than one or more second wavelengths of the signal spectrum; and
at least one of:
the coupling efficiency over the Raman spectrum is higher than over the signal spectrum; or
the mode filter is to attenuate the second guided mode more than a first guided mode.

4. The fiber optic device of claim 2, wherein:
the first and second guided modes comprise linearly polarized (LP) modes;
the first guided mode is a fundamental LP mode; and
the second guided mode is an odd-ordered LP mode.

5. The fiber optic device of claim 1, wherein:
the mode coupler comprises:
a third length of fiber comprising a core and one or more cladding layers; and
a fiber grating (FG) within the core, the FG having a refractive index that varies over the third length of fiber.

6. The fiber optic device of claim 5, wherein the FG has a refractive index that varies azimuthally within the core.

7. The fiber optic device of claim 5, wherein:
the FG is a long-period grating having a period greater than half of a center wavelength of the Raman spectrum; and
the FG is optically coupled between the mode filter and an optical resonator, the optical resonator to excite at least the signal spectrum.

8. The fiber optic device of claim 5, wherein:
the FG is a short-period grating having a period no longer than half of a center wavelength of the Raman spectrum; and
the mode filter is optically coupled between the FG and an optical resonator, the optical resonator to excite at least the signal spectrum.

9. The fiber optic device of claim 7, wherein the optical resonator comprises the first length of fiber and supports only the first guided mode.

10. The fiber optic device of claim 9, wherein the second length of fiber comprises a gain medium to excite at least the signal spectrum.

11. The fiber optic device of claim 2, wherein the mode filter comprises a transition between a multi-mode fiber and a single-mode fiber.

12. The fiber optic device of claim 11, wherein the transition comprises a differential core splice.

13. A fiber system, comprising:
a laser to generate an optical beam when energized;
a first length of optical fiber coupled to the laser to receive the optical beam, the first length of fiber comprising a core and one or more cladding layers, wherein the first length of fiber supports a first guided mode for light comprising both signal spectrum and Raman spectrum;
a second length of optical fiber comprising a core and one or more cladding layers, wherein the second length of optical fiber supports multiple guided modes; and
a mode coupler between the first and second lengths of fiber, the mode coupler to couple at least some of the light in the first guided mode into a second guided mode with a coupling efficiency over the Raman spectrum that differs from that over the signal spectrum.

14. The fiber system of claim 13, further comprising. a mode filter coupled to receive the light from the first or second lengths of fiber, and to discriminate between the first and second guided modes.

15. The fiber system of claim 14, wherein:
the first and second guided modes comprise linearly polarized (LP) modes;
the first guided mode is a fundamental LP mode;
the second guided mode is an odd-ordered LP mode;
the Raman spectrum comprises one or more first wavelengths that are longer than one or more second wavelengths of the signal spectrum;
the mode coupler comprises a Fiber Bragg Grating (FBG) having a refractive index that varies over a third length of fiber; and
the mode filter is a fiber mode filter that guides a fundamental mode more efficiently than one or more higher-order modes.

16. A method of filtering Raman spectrum from a fiber system, the method comprising:
propagating a first guided mode of light in a first optical fiber length of the system, the first fiber length comprising a core and one or more cladding layers, and the light comprising both signal spectrum and Raman spectrum;
coupling at least some of the light from the first guided mode into a second guided mode, wherein a coupling efficiency over the Raman spectrum differs from that over the signal spectrum;
propagating first and second guided modes in a second optical fiber length of the system, the second length of fiber comprising a core and one or more cladding layers; and
filtering the light in a manner that discriminates between the first and second guided modes.

17. The method of claim 16, wherein:
coupling at least some of the light comprises coupling the Raman spectrum more efficiently than the signal spectrum; and
guiding the first mode in a core of the second fiber length more efficiently than the second mode.

18. The method of claim 16, wherein:
the first guided mode is a fundamental LP mode;
the second guided mode is an odd-ordered LP mode; and
coupling at least some of the light comprises:
propagating the light in a third length of fiber comprising a core and one or more cladding layers, the third length of fiber comprising fiber grating (FG) within the core, and the FG having a refractive index that varies over the third length of fiber.

19. The method of claim 18, wherein the FG is a long period grating having a period greater than half of one or more wavelengths in the Raman spectrum; and
coupling at least some of the light comprises co-propagating the second guided mode.

20. The method of claim 18, wherein the FG is a short period grating having a period no longer than half of one or more wavelengths in the Raman spectrum; and
coupling at least some of the light comprises back propagating the second guided mode.
